(19) United States
(12) Patent Application Publication
(10) Pub. No.: US 2025/0336144 A1
(43) Pub. Date: Oct. 30, 2025

(54) Private and Decentralized 3D from Crowd Sourced Image Data

(71) Applicants: Massachusetts Institute of Technology, Cambridge, MA (US); William Marsh Rice University, Houston, TX (US)

(72) Inventors: Akshat DAVE, Cambridge, MA (US); Ramash RASKAR, Cambridge, MA (US); Abhishek SINGH, Cambridge, MA (US); Zaid TASNEEM, Houston, TX (US); Kushagra TIWARY, Cambridge, MA (US); Ashok VEERARAGHAVAN, Houston, TX (US); Praneeth VEPAKOMMA, Weymouth, MA (US)

(73) Assignees: Massachusetts Institute of Technology, Cambridge, MA (US); William Marsh Rice University, Houston, TX (US)

(21) Appl. No.: 19/195,045

(22) Filed: Apr. 30, 2025

Related U.S. Application Data
(60) Provisional application No. 63/640,404, filed on Apr. 30, 2024.

(51) Int. Cl. G06T 15/20; G06V 10/774; G06V 10/82; G06V 20/30

(52) U.S. Cl. CPC G06T 15/205; G06V 10/774; G06V 10/82; G06V 20/30

(57) ABSTRACT

In one aspect, a method for rendering of a 3D aggregate image from crowd sourced image data is provided. The method includes receiving, at a server, from each of a plurality of user devices, user global multi-layer perceptron (MLP) weights generated from one or more images of a shared scene. The user global MLP weights are generated so as to not include personal content of a user. The method also includes aggregating the user global MLP weights using secure multi-party computation (SMPC) to further ensure exclusion of personal content. The method also includes sending, from the server to the plurality of user devices, updated weights, wherein the updated weights comprise aggregated global MLP weights. The user devices may then use the updated weights to further help in the implicit separation of personal and global content while retraining of their respective weights on local image data.

### CROSS-REFERENCE TO RELATED APPLICATIONS

This application is a U.S. Nonprovisional application which claims the benefit of U.S. Provisional Application No. 63/640,404, filed Apr. 30, 2024, and is hereby incorporated by reference in its entirety.

### STATEMENT REGARDING FEDERALLY SPONSORED RESEARCH

This invention was made with government support under grant number CCF2200269 awarded by The National Science Foundation. The government has certain rights in the invention.

### BACKGROUND

Neural radiance fields (NeRFs) show potential for transforming images captured worldwide into immersive 3D visual experiences. However, most of this captured visual data remains siloed in camera rolls as these images contain personal details. Even if made public, the problem of learning 3D representations of billions of scenes captured daily in a centralized manner is computationally intractable.

Every day, more than 5 billion photos are captured worldwide, comprising multiple viewpoints of every monument, skyscraper, cafe, and concert on Earth. Neural radiance fields (NeRFs) present an exciting opportunity to process this massive data into immersive visual experiences at a global scale. However, most of these images remain siloed in personal camera rolls. Less than 2% of these captured photos are ever posted on the internet.

Even if these personal images were made public, training NeRFs for billions of scenes captured daily at a global scale in a centralized fashion is computationally intractable.

Conventional systems, such as NeRF-W achieve the high visual quality of the public global scene from in-the-wild crowd-sourced images, but the personal user images are transferred to a central server for training. This results in personal content directly being accessed by the server and high server compute.

### SUMMARY

The above problems are overcome, and other advantages may be realized, using the embodiments. The present invention addresses these needs with a decentralized, crowd-sourced NeRFs (DecentNeRF). User devices locally process images into intermediate 3D representations that explicitly separate private (personal/local) 3D data from public (global) 3D information. Subsequently, the server aggregates these global, privacy-preserving 3D representations received from multiple user devices to refine and enhance a unified, non-private 3D representation of the scene.

In one aspect, a method for learning 3D representations from crowd-sourced images is provided. The method includes receiving, at a server, from user devices, individual global 3D representations encoded as local multi-layer perceptron (MLP) weights. The user global MLP and personal MLP weights are derived by the user devices to separate personal content from global content within captured image data. The server securely aggregates the received user global MLP weights using a secure multi-party computation (SMPC) protocol to produce server global MLP weights representative of the shared scene. The aggregated global MLP weights are then transmitted from the server back to the user devices. Upon receiving the updated global MLP weights, user devices utilize these weights to refine the distinction between personal and global 3D representations, thereby enhancing the privacy-preserving quality of future processed data.

Various embodiments, such as DecentNeRF, avoid the issues, such as, security problems and computational loading at the server faced by the conventional system. DecentNeRF addresses the challenges of learning global 3D scene representations at scale from crowd-sourced images in a decentralized manner. The systems use personal-global separation and a learned federation scheme to achieve high-quality reconstruction of 3D scenes with low server computing compared to prior approaches.

While conventional systems are centralized by nature (i.e., the captured images are sent to the server for training NeRFs), DecentNeRF diverges from traditional work by focusing on decentralization to 1) distribute the NeRF training compute to the user devices and thus scale to billions of scenes and 2) avoid accessing user devices' images, which could contain personal details.

In Federated Learning (FL), each client device trains the model parameters on-device using its own local data. The server then performs a weighted average of the models to obtain a server (shared) global model and this process continues until convergence. Since NeRFs are 3D representations sharing the 3D representations instead of raw data could still lead to reconstruction of the personal data. DecentNeRF models of the local 3D scene representation are a combination of a global radiance field for the 3D scene-specific details and a personal radiance field for the user-specific information. This decoupling considers each sample to be composed of personal and non-personal information. Hence, the goal is still to learn a single global consistent scene across multiple user devices.

In a further aspect, a method for generation of a 3D image from crowd sourced image data is provided. The method includes receiving, at a server, from each of a plurality of user devices, user global multi-layer perceptron (MLP) weights generated from one or more images of a shared scene. The user global MLP weights are generated so as to not include personal content of a user. The method also includes aggregating the user global MLP weights using secure multi-party computation (SMPC) to further ensure exclusion of personal content. The method also includes sending, from the server to the plurality of user devices, updated weights, wherein the updated weights comprise aggregated global MLP weights.

In another embodiment of the method above, the method also includes sending, from the server to the plurality of user devices, initial weights.

In a further embodiment of the method above, the one or more images of the shared scene comprise one or more 2-dimensional (2D) images of the shared scene.

In another embodiment of the method above, the one or more images of the shared scene comprise a plurality of images taken at different angles, distances, and times. The one or more images of the shared scene may include personal content and global content. The global content is static content across a plurality of images.

In a further embodiment of the method above, the personal content is dynamic content across a plurality of images.

In another embodiment of the method above, the method also includes taking at least one 2-dimensional (2D) photo on a first user device of the user devices. The method also includes processing, by the first user device, the at least one 2D photo to train associated global MLP weights. Training is performed with a neural radiance field (NeRF) pipeline learns associated user global MLP weights and personal MLP weights. Processing separates personal content from the at least one 2D photo. The method also includes sending, from the first user device to the server, the associated user global MLP weights while keeping personal MLP weights local to the first user device.

In a further embodiment of the method above, the method also includes receiving, from the server to the plurality of user devices, the updated weights. The method also includes processing, by the first user device, the at least one 2D photo to generate updated user global MLP weights using the updated weights; and sending, from the first user device to the server, the updated user global MLP weights.

In another embodiment of the method above, the method also includes obfuscating the updated user global MLP weights before sending the updated user global MLP weights to the server.

In a further embodiment of the method above, the method also includes sending, from the first user device to the server, metadata and/or features associated with 3-dimensional (3D) photo data for camera pose estimation.

In an additional aspect, a server for generation of a 3D image from crowd sourced image data is provided. The server includes at least one processor; and at least one memory storing computer program code. The at least one memory and the computer program code are configured to, with the at least one processor, cause the server to perform actions. The actions include to receive, at the server, from each of a plurality of user devices, at least one global multi-layer perceptron (MLP). The at least one global MLP includes 3-dimensional (3D) data of a shared scene. The at least one global MLP includes weights used by the user device to remove personal content from a source document during generation of updated user global MLP weights. The actions also include to combine the received global MLP to generate a securely aggregated global MLP of the shared scene. The actions also include to determine updated weights based on the securely aggregated global MLP. The actions also include to send, from the server to the plurality of user devices, the updated weights. The updated weights include global MLP weights.

In a further embodiment of the server above, the personal content is dynamic content across a plurality of images.

In another aspect, a user device for generation of a 3D image from crowd sourced image data is provided. The user device includes at least one processor; and at least one memory storing computer program code. At least one memory and the computer program code are configured to, with the at least one processor, cause the user device to perform actions. The actions include to take at least one photo of a shared scene. The actions also include to receive initial global multi-layer perceptron (MLP) weights from a server. The actions also include to process the at least one photo to train user global MLP weights and personal MLP weights. Training separates personal content from global content from the at least one photo. The actions also include to send, to the server, the user global MLP weights. The actions also include to receive, from the server, updated global MLP weights.

In a further embodiment of the user device above, the at least one photo includes a 2-dimensional photo of the shared scene.

In another embodiment of the user device above, the at least one photo of the shared scene comprises a plurality of images, and the personal content is dynamic content across the plurality of images.

### BRIEF DESCRIPTION OF THE DRAWINGS

The foregoing features may be more fully understood from the following description of the drawings in which various aspects of the concepts and embodiments described herein are described. It should be appreciated the figures are not necessarily drawn to scale. In the drawings, each identical or nearly identical component that is illustrated in various figures is represented by a like numeral. For purposes of clarity, not every component may be labeled in every drawing.

FIG. 1A is a block diagram showing various devices suitable for practicing various embodiments.

FIG. 1B is a signaling diagram illustrating communications between various devices practicing an embodiment.

FIG. 2 is a schematic diagram showing operation of DecentNeRF, according to some embodiments.

FIG. 3 is a schematic diagram of a sample DecentNeRF architecture.

FIG. 4 shows multiple source images having varying levels of occlusion.

FIG. 5 shows a bar graph indicating contributions of the images from FIG. 4 to the processing weights.

FIG. 6 demonstrates aggregate renderings by various techniques.

FIGS. 7A-7B illustrate a source image and an associated processed image.

FIGS. 8A-8B illustrate another source image and an associated processed image.

FIGS. 9A-9B illustrate potential issues with various aggregate images.

FIG. 10 illustrates an image that may be generated according to some embodiments.

FIG. 11 is a block diagram illustrating selective components of an example computing device in which various aspects of the disclosure may be implemented, in accordance with an embodiment of the present disclosure.

FIG. 12 is a block diagram illustrating selective components of an example computing device in which various aspects of the disclosure may be implemented, in accordance with an embodiment of the present disclosure.

### DETAILED DESCRIPTION

Various embodiment, provide a decentralized, crowd-sourced NeRFs (called DecentNeRF) that uses less server computing for a scene than a centralized approach. Instead of sending the raw data, user devices send processed images so as to distribute the high computation cost of training centralized NeRFs between the user devices. The user devices can create photorealistic scene representations by locally decomposing the raw images into personal and global 3D data. The global weights learned by the user devices can be provided to the central server. The server can aggregate and optimize the weights which in turn can be provided back to the user devices for additional processing.

To build immersive visual experiences at a global scale, decentralized NeRFs can be used to handle high computation needs and avoid the undesired reconstruction of personal content by a central entity, all the while ensuring photorealism.

Images in public spaces are often composed of global content, e.g., a monument, and personal content, such as a friend posing in front of the monument. Often global content is static across user devices, and the personal content is dynamic, e.g., varies from user to user. This association of global as static and personal as dynamic allows DecentNeRF to perform global-personal separation in the captured images. The global scene-specific 3D representations across user devices can be shared instead of the combined (global and dynamic) image as in a conventional NeRF pipeline. In doing so, the system distributes the NeRF training computation across user devices and avoids the cost of centrally training NeRFs at the server. It also prevents the reconstruction of undesired occlusions of personal user-specific content at the server.

For a particular scene, the multi-view visual data is a combination of a global radiance field for the 3D scene of interest and a personal radiance field for the user's personal information (transient across user devices). A federated learning procedure can be used to learn the global radiance field across user devices by aggregating only the user device's global radiance field model (which is locally trained). Instead of uniformly averaging the user devices' weights as typical in federated learning, a federation procedure can be used where the per-user scaling is learned implicitly to maximize visual fidelity. To prevent the server from accessing the individual user device's global radiance fields, a secure multi-party computation (SMPC) protocol is used for aggregation. The secure aggregation prevents the re-construction of personal content by the server compared to existing approaches during initial rounds of federation.

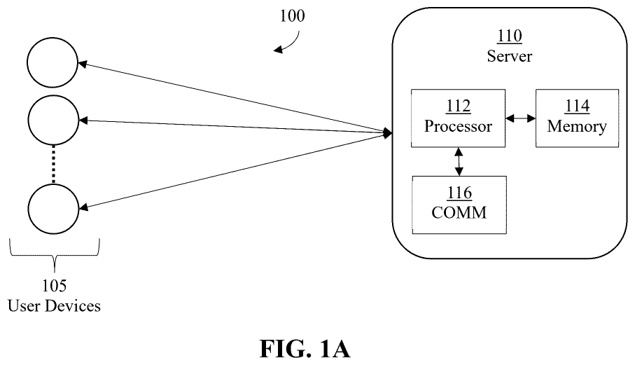

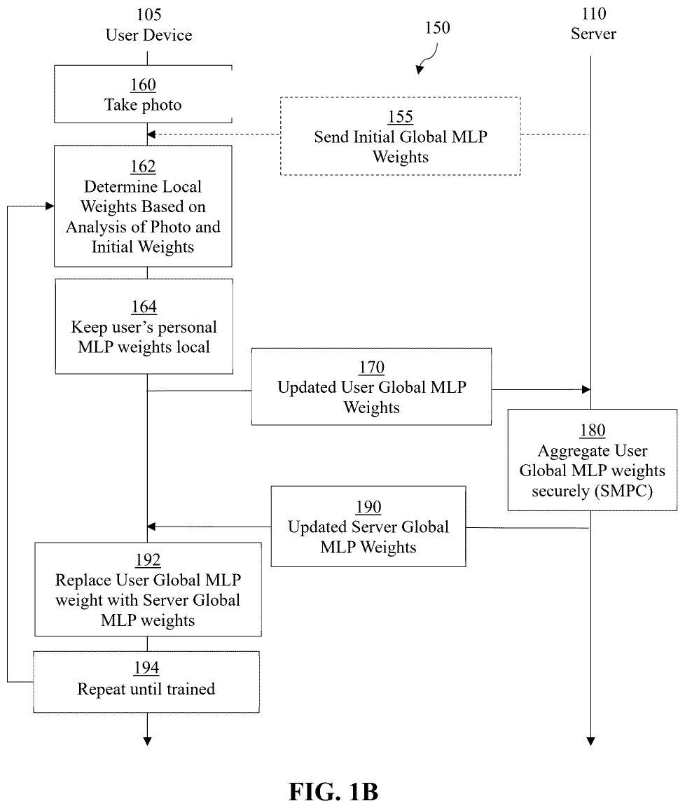

FIG. 1A shows a block diagram of various devices suitable for practicing various embodiments. A system 100 includes user devices 105 and a server 110. The server 110 has a processor 112 and a memory 114. The processor 112 is configured to work with the memory 114 in order to perform various actions in accordance with various embodiments. The server 110 also has a communication interface (COMM) 116 in order to communicate with user devices 105.

Consider a scenario where users visit a famous restaurant in town at different times over months capturing images that are now saved on their personal photo galleries. In addition to visual content depicting the restaurant scene, these images likely contain personal content that users would not want to share publicly.

Various embodiments, such as DecentNeRF, use a decentralized approach where a server can learn a 3D representation of the restaurant, given such a cluster of user devices and their captured images. This is a challenging problem as the learned scene representation encodes both the appearance and 3D structure of the scene while not revealing the personal image content to the server. To create a global-level 3D representation, this process is repeated for millions of user devices and locations (restaurants, monuments, etc.) which puts a compute constraint on the server learning the scene representation. DecentNeRF achieves photorealistic 3D reconstruction with minimal server computing and undesired reconstruction of personal content.

FIG. 1B shows a signaling diagram 150 of communications between a user device 105 and a server 110 practicing such an embodiment. As shown, the communications between a single user device 105 and the server 110; however, the server 110 may communicate with multiple additional user devices in similar format.

The user device 105 takes one or more photos at step 160. The photos may be a 2-dimensional (2D) or 3-dimensional (3D) image. The photos may include both global content (e.g., the restaurant) and personal content (e.g., a person sitting at a table).

Optional message 155 may be provided by the server 110 to send global MLP initial weights for learning 3D representation of the landmark. This may be sent when the user device 105 takes the photos (e.g., based on geolocation information). Alternatively, the user device 105 may send a request for the initial global MLP weights.

At step 162, the user device 105 processes the photos to train user device's global and personal MLP weights. The processing may include training the local weights based on the initial weights and the photos. This process enables the personal MLP to implicitly learn the personal content in the images while the global MLP learns the 3D global content.

At step 170, the user device 105 sends the user device's global MLP weights to the server 110.

At step 180, the server 110 takes the user devices' global MLP weights and aggregates them using a secure multi-party computation (SMPC) protocol. This ensures that only the average of all the user devices' global MLPs is received by the user device. This helps ensure the privacy of the information.

At step 190, the averaged server global MLP weights are sent to all the user devices. The server 110 may also update the user device's global MLP weights from the ones received from the server at step 192, for future processing.

Step 194 involves finetuning of the personal MLP weights in conjunction with the updated user global MLP weights. This process further refines the separation of the personal and global content into personal and global MLP weights respectively. This allows the process to repeat step 162 and the subsequent steps until the updated weights are deemed sufficiently trained.

By shifting the processing to the user devices 105, the server 110 can more efficiently handle the load of creating a shared 3D representation of a scene. The training of NeRF MLP weights is done in parallel for all user devices and thus the time needed to train the whole NeRF is significantly reduced by the factor proportional to the number of user devices.

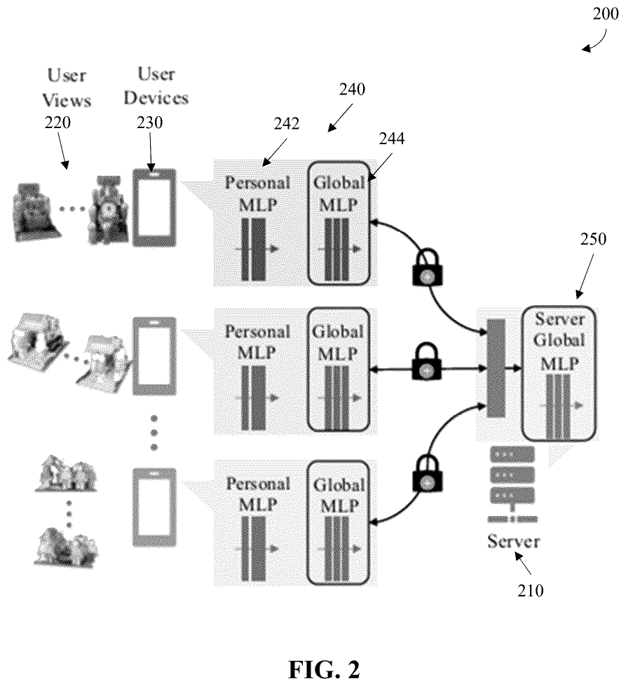

FIG. 2 illustrates an overview of an embodiment. Multi-layer perceptrons (MLPs) 240 include personal MLPs 242 and global MLP 244. The personal MLPs 242 and global MLPs 244 are trained on user devices 230 to separate personal and global content from local images, such as user views 220. After each training round, the server 210 performs a learned federation of user devices' global MLPs 244 using a secure MPC protocol and distributes the updated global MLP 250 back to each user device. This helps reduce personal content leakage: The user devices' global MLPs 244 may contain personal content during the initial rounds. The secure MPC protocol ensures the server 210 sees the averaged global MLP 244 from which the rendering of users' personal content is minimal. Over federation rounds, global MLPs 244 and personal MLPs 242 separate content through learned weighted averaging, enabling high-fidelity rendering from the server's global MLP 250.

Accessing individual model updates from the user devices in FL could potentially lead to data reconstruction attacks. Therefore, secure aggregation averages model updates such that only the final averaged weights are revealed to the untrusted central server. This is accomplished by encrypting individual model updates by each user device such that only the final average can be decrypted. To compute the average of encrypted user models, existing techniques rely on primitives such as secure multi-party computation (SMPC). Various embodiments use SMPC-based secure aggregation as a building block to perform weighted averaging over encrypted model updates.

Neural radiance fields (NeRFs) excel at encoding 3D scene information using multilayer perceptrons (MLPs). Existing decentralized solutions collaboratively learn a shared NeRF MLP representation with each user device's local views. The user devices can refine the MLPs locally and in parallel, offloading compute from the server. The server only needs to aggregate user MLP updates into a combined shared MLP and transmit this back to user devices for further refinement. Over multiple federation rounds, this approach aims to reconstruct a 3D scene with the shared MLP. Such a federated method requires orders of magnitude less server computation than centralized approaches, aligning with the stated decentralization goal.

However, existing federated NeRF performs poorly on crowdsourced images. The approaches assume input view consistency—that any 3D point observed from user devices' images is static. The underlying assumption is that all user devices took all images at the same instant, only capturing the global scene content and avoiding personal data. These assumptions do not hold for crowdsourced images taken over months and contain personal content like users, their food, or credit cards which are transient across user devices. Violations of these assumptions would hamper reconstruction quality and leak personal content from the shared MLPs. In contrast, DecentNeRF exploits the structure of these violations to learn photorealistic global 3D scene content in a decentralized manner.

The global scene-specific content is 3D view-consistent (static) across user devices such as the columns and most of the restaurant's interior. By definition, all other 3D content is transient across user devices, be it non-personal, like the wait staff, or personal and sensitive, like the user, or a credit card on the table. Encoding 3D appearance between personal and global MLPs leverage the juxtaposition between scene-specific and user-specific content and captures personal and global content, respectively. The global MLP is federated at the server to form the combined global MLP. This allows for high-quality reconstruction of global content over multiple rounds of federation.

User devices likely have different data distributions-number of views, disparity, and user/scene content ratios. Naive federated averaging of global MLP is suboptimal. DecentNeRF instead learns aggregation weights over federation rounds for improved reconstruction quality.

During the initial rounds, the user global MLPs may encode both personal and global content. This is because user devices initially have no notion of global or personal content without federation across user devices. If the server has access direct access to the user devices' global MLPs, which is the case for existing FL NeRF methods, the server can faithfully render the personal content. To prevent the server from outright accessing the individual user device's global MLPs, secure multi-party computation (SMPC) aggregation is used. This allows the server to access averaged global MLP at each round. The securely aggregated server global MLPs allow minimal reconstruction of personal content during initial rounds.

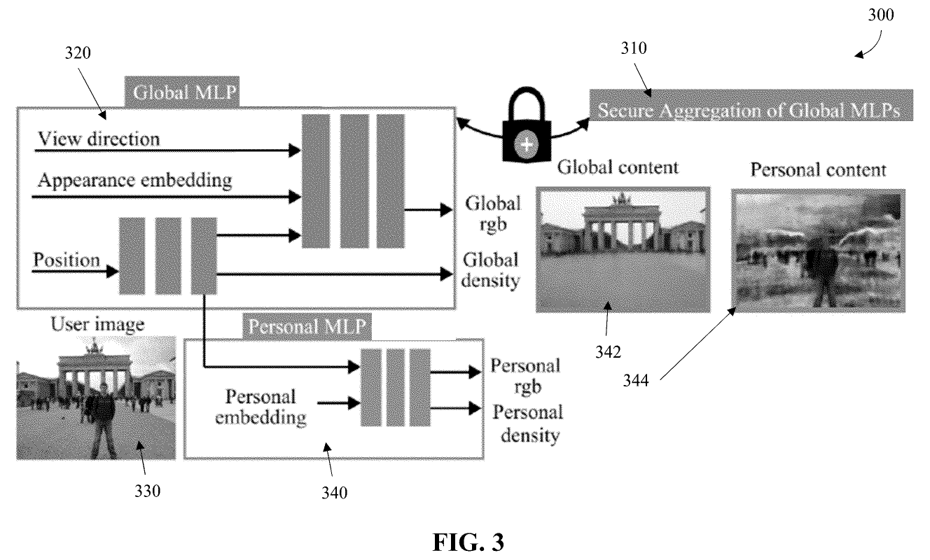

FIG. 3 demonstrates a sample DecentNeRF architecture. On a user device, the personal MLP 340 is local to the user device. The user device processes user images, such as image 330, and determines global MLP 320 and personal MLP 340. As one example, the user image 330 is processed to generate global content 342 by removing personal content 344.

The weights of global MLP 320 are securely aggregated at the server to generate aggregated global MLP 310. This aggregated global MLP 310 may be sent back to the user device for further processing of the user image.

DecentNeRF learns to represent its Global and Personal MLPs.

Decentralized NeRF approaches have total computing (both server and user device computing) similar to a centralized approach (focused on the server) for training NeRFs. However, in the case of decentralized systems, the training of NeRFs is distributed to the user devices to reduce server computing significantly.

DecentNeRF treats personal content as transient across user devices. Not all clients have taken images at the same instant, which is often the case for crowd-sourced images. It ensures that the personal content is transient and not static across user devices like the global content. Additionally, there is significant overlap in views. No single user device has views that don't overlap with another user device.

From a user device's perspective, the server and other user devices are un-trusted. Unlike differential privacy, which prevents identity leakage, DecentNeRF prevents the reconstruction of user-specific semantic personal information by the server. This stops the server from reconstructing a target user device's personal information from the averaged model updates.

NeRF can train a multi-layer perceptron (MLP) that takes a 5D input vector: a 3D spatial coordinate x=(x, y, z) within the scene, and pitch θ and yaw ϕ parameters of the viewing direction d. The MLP outputs a scalar density σ and an RGB color vector c=(r, g, b). NeRF rendering synthesizes images via volume rendering, sampling predicted color and density at many points along rays traversing the scene. For a particular ray corresponding to a pixel, the MLP predicts a color vector c=(r, g, b) and compares the color vector with a ground truth RGB value, using the loss to train the MLP weights.

Regarding personal-global content separation, consider a scene with K known user devices. For each user device k, the scene is modeled using global and personal MLPs (as shown in FIG. 3) with the MLP weights denoted as gₖ and pₖ respectively. The personal MLPs 340 are kept native to the user's device. In contrast, the global MLP 320 captures shared global content (such as the landmark) across user devices via federation. Each MLP outputs its scalar density σ and an RGB color c=(r, g, b), so the rendered image is an alpha-composite of both output images.

Each user device may be considered as running NeRF in the Wild (NeRF-W) locally. The global MLPs 320 and personal MLPs 340 are analogous to the static and transient MLPs in the context of a single user device. However, the global-personal definition suits the decentralized setting since NeRF-W's transient MLP does not separate all of the personal content from the user device.

If a subject were being recorded in front of a monument with multiple images. The subject would be static across multiple views within the user device's images and would not appear in the transient MLP even though it is transient across user devices. The federation of global MLP across user devices over multiple rounds can separate this user-static but transient across user-specific content into the personal MLP branch and lead to high-quality reconstructions.

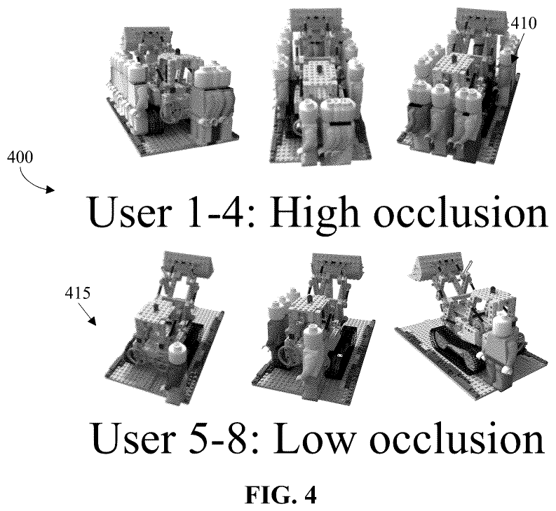

FIG. 4 shows multiple source images 400. The images are separated into high occlusion images 410 and low occlusion images 415. With Learned Federation of Global MLPs, DecentNeRF learns to weigh clients with less occlusion over thirty (30) rounds of training which leads to better reconstruction quality overall compared to one with FedAvg aggregation scheme e.g. DecentNeRF(-L) and FedNeRF.

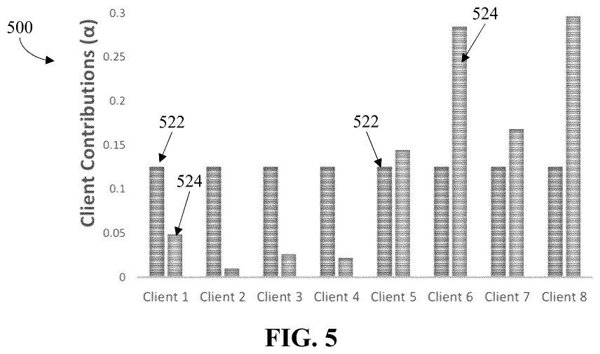

FIG. 5 shows a bar graph 500 indicating round one (1) contributions 522 and round thirty (30) contributions 524 for each client to the processing weight, a. As shown, the high occlusion images 410 and low occlusion images 415 result in similar round one (1) contributions. However, high occlusion images 410 provide significantly more round thirty (30) contributions 524.

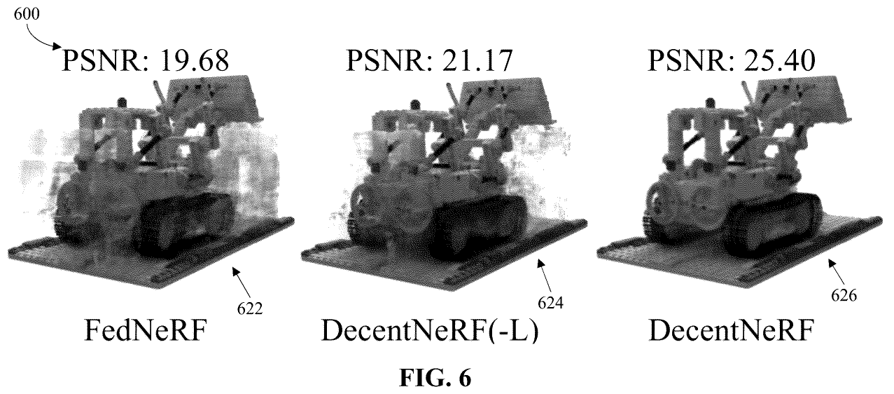

These existing definitions lead to suboptimal reconstruction performance as shown in FIG. 6 because all user devices have different data distributions-number of views, view disparity, user/scene content ratios and would be able to do different levels of global-personal content decomposition to benefit the server's global representation. FIG. 6 shows renderings 600 for comparison. The FedNeRF 622 rendering has a peak-signal-to-noise ratio (PSNR) of 19.68, while the DecentNeRF(-L) generated image 624 has a PSNR of 21.17 and the DecentNeRF generated image 624 has a PSNR of 25.40. Accordingly, the DecentNeRF generated image 627 has a superior reconstruction quality.

The global MLP weights at any aggregation round m, are defined as g^{(m)}=Σαₖ^{m}·gₖ^{m}. In a naive federated learning approach, all user devices are weighted equally, αₖ=1/K. Existing procedures define the user devices based on the number of pixels in their image data,

$${α}_{k} = \frac{{p}_{k}}{{\sum }_{k = 1}^{K} {p}_{k}} ,$$

where pₖ is the total number of image pixels in the user data.

In contrast, the various embodiments learn a implicitly over different merge rounds by the following equation:

$${α}_{k}^{( m )} = {α}_{k}^{( m - 1 )} - μ \frac{\partial L}{\partial {α}_{k}^{( m - 1 )}} \qquad ( 1 )$$

where η is the weighted averaging learning rate, and the cumulative loss L is defined as the sum of losses for each user device k, L=ΣₖLₖ, where

$${L}_{k} ( {g}_{k}^{m - 1} , {p}_{k}^{m - 1} ,$$

I_{GT}) is the training loss defined.

The loss implicitly rewards the user device's weightage, αₖ when they do a better global-personal decomposition in the previous round's aggregation. Combining the above with the update equation for αₖ, yields:

$${\frac{\partial L}{\partial {α}_{k}}}^{( m - 1 )} = ( \sum \frac{\partial {L}_{k}}{\partial {g}^{( m - 1 )}} ) \cdot {g}_{k}^{m - 1} \qquad ( 2 )$$

Beyond the first round of aggregation, each user device sends its own

$$\frac{{L}_{k}}{{g}^{( m - 1 )}} ,$$

which is aggregated by the server and sent back to the user devices. This aggregated value gets multiplied with the previous round's user weights at the user device to update each user device's αₖ at every round.

As shown, a centralized approach achieves improved photorealism performance while using more server compute than decentralized approaches. Existing centralized approaches, such as FedNerf, perform poorly on photorealism metrics when compared to DecentNeRF. Decent NeRF obtains comparable photorealism to the FedNerf approach with several orders of magnitude lower sever compute.

From the user device's perspective, in every round, there are two kinds of messages that each user device k communicates with the server—1) weights of the global MLP, gₖ, and 2) gradients with respect to the per-user loss, g

$$\frac{{L}_{k}}{{g}^{( m - 1 )}} k .$$

The user device also computes gradient updates of

$$α = ( \frac{\partial {L}^{( m - 1 )}}{\partial {α}_{k}} ) .$$

The user devices obfuscate the user device communications such that the final result aggregated over all the user devices is visible to the server. From the server's perspective, the server computes the weighted average of the obfuscated weights sent by the user devices g^{(m)}, and the cumulative loss

$$\sum \frac{\partial {L}_{k}}{\partial {g}^{( m - 1 )}} .$$

Each of these functional elements is satisfied using secure multi-party computation.

Each user device can obfuscate its local weights (multiplies with αₖ) by applying a random mask or encrypting data using additively homomorphic encryption techniques. This randomization ensures that when the obfuscated weights are aggregated and the original values cannot be recovered from those weights. Additionally, the system still has the means to calculate the weighted average accurately. Each user device can also communicate local gradients by performing randomized obfuscation to its gradients in a similar way the weights are obfuscated.

The server can calculate the weighted average of the obfuscated weights sent by the user devices (g(m)). By employing secure multi-party computation techniques, the server can aggregate the masked weights received from all user devices.

Using the techniques described above, DecentNeRF can begin with a random initialization of global G⁽⁰⁾ and personal MLP weights P⁽⁰⁾ at all K user devices. For each round the user devices return their current gₖ^{m} and previous rounds global MLP along with loss gradients of previous round global MLP weights

$$\frac{\partial {L}_{k}}{\partial {g}^{( m - 1 )}} .$$

The user devices can also calculate the gradient updates for αₖ. On the server, the weights and previous rounds gradients are securely aggregated and sent back to the user devices.

DecentNeRF, a decentralized framework for learning NeRFs, enables global-scale crowd-sourced NeRFs. DecentNeRF decomposes multi-view images into personal and global visual content. It then securely aggregates the global content across user devices with high visual fidelity while minimizing the reconstruction of personal content on the server.

DecentNeRF provides a decentralized NeRF approach for capturing large-scale 3D scenes and live events, facilitating widespread adoption of NeRFs.

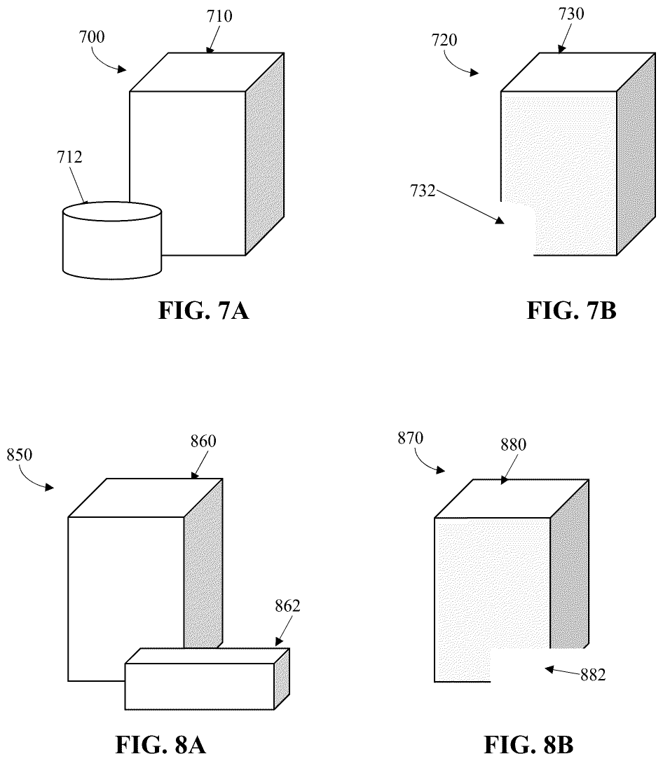

FIGS. 7A-8B illustrate source images and processed images. FIG. 7A shows a raw image 700 with a shared scene element 710 (e.g., a building) that is partially obscured by private/dynamic element 712. Once processed from the user device's global MLP, the rendered image 720 includes a portion 730 of the shared scene element 710 with removed section 732. In various embodiments, such a rendered image 720 is not shared with the server or even created; rather, the rendered image 720 is described here for reference.

Likewise, FIG. 8A shows a raw image 850 with a shared scene element 860 (e.g., the same building but possibly at a different angle or time). Shared scene element 860 is partially obscured by private/dynamic element 862 (e.g., a bus). Once processed from the user device's global MLP, the rendered image 870 includes a portion 880 of the shared scene element 860 with removed section 882.

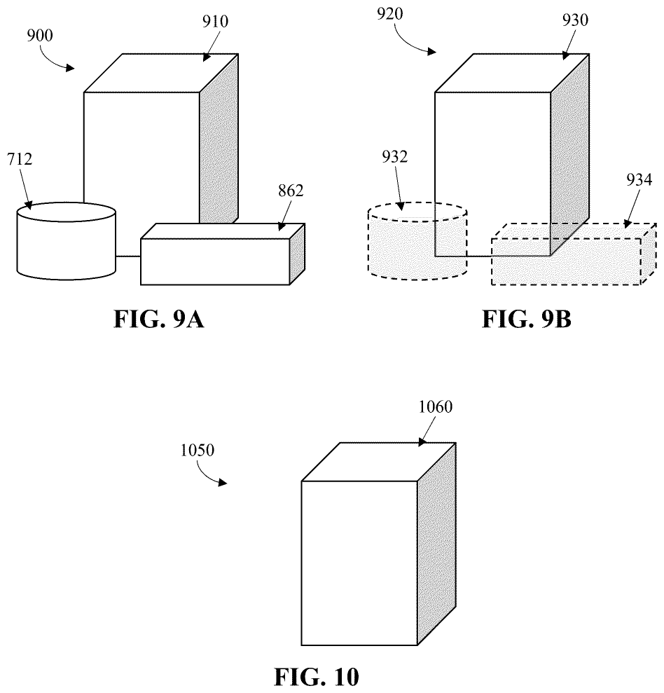

FIG. 9A illustrates a first aggregate image. Combining the raw image 700 and the raw image 720 could produce image 900. Here, the shared scene element 910 may be a combination of shared scene element 710 and shared scene element 860. However, the combination 700 includes both private/dynamic element 712 and private/dynamic element 862.

FIG. 9B illustrates a different aggregate image 920. The shared scene element 930 is present but obscured by elements 932 (matching private/dynamic element 712) and element 934 (matching private/dynamic element 862). This could be due to the local weights used for processing the images.

FIG. 10 illustrates a desired aggregate image 1050, for example, created by an embodiment. The shared scene element 1060 is present and not obscured. By using updated global weights for processing the raw images, local devices can be used to process the image and create intermediate 3D data of the shared scene. The intermediate 3D data is better prepared for aggregation and avoids inclusion of private/dynamic data. The intermediate 3D data, rather than image data, may be used to create the aggregate image 1050. Additionally, by performing the processing on the individual user devices, the system can avoid computational bottlenecks at the server, for example, many images may be processed simultaneously by the user devices.

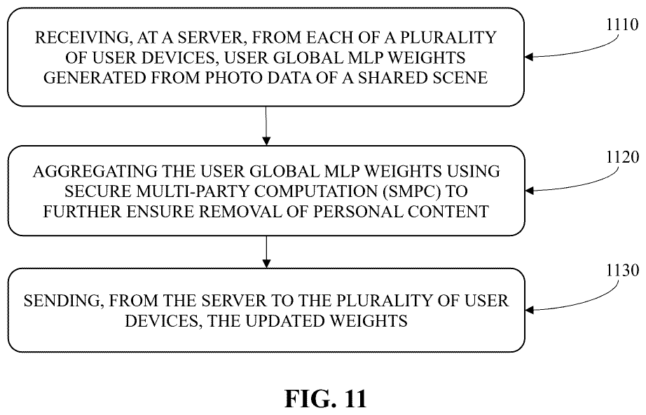

FIG. 11 is a logic flow diagram that illustrates the operation of a method, and a result of execution of computer program instructions embodied on a computer readable memory, in accordance with various embodiments. The method can be used to generate a 3D representation from crowd sourced image data and provide updated weights from the server to the user devices for processing raw image data.

The method includes, at Block 1110, receiving, at a server, from multiple user devices, user global multi-layer perceptron (MLP) weights generated from one or more images of a shared scene. The user global MLP weights are weights are designed to not contain personal content from a user source. The method also includes, at Block 1120, aggregating the user global MLP weights using secure multi-party computation (SMPC) to further ensure removal of personal content. At Block 1130, updated weights are sent from the server to the user devices. The updated weights include aggregated global MLP weights

The user devices may then use the updated weights to re-process the original image data and/or process new image data. Additionally, a new user device may request the updated weights in order to process raw image data of the shared scene.

Various embodiments provide for training neural radiance fields (NeRFs) in a privacy-aware and decentralized manner. The creation of interactive 3D neural scene representations (NeRFs) from a large collection of crowd-sourced images can be performed while preserving user device privacy. By establishing private and public (or global) radiance fields, user devices can remove private content from the user NeRF models data before sending them for aggregation. The system can collaboratively train the global radiance field representations on a central server by aggregating model updates from different user devices, without accessing private user device data.

Embodiments may be used to securely generate photo-tourism and immersive 3D experiences. The aggregate images may be used to generate 3D spaces and environments of existing locations. Additionally, the aggregate images can recreate locations during specific events (for example, by limiting the source images to those taken during the event), allowing users to experience concerts, sporting events, conferences, etc.

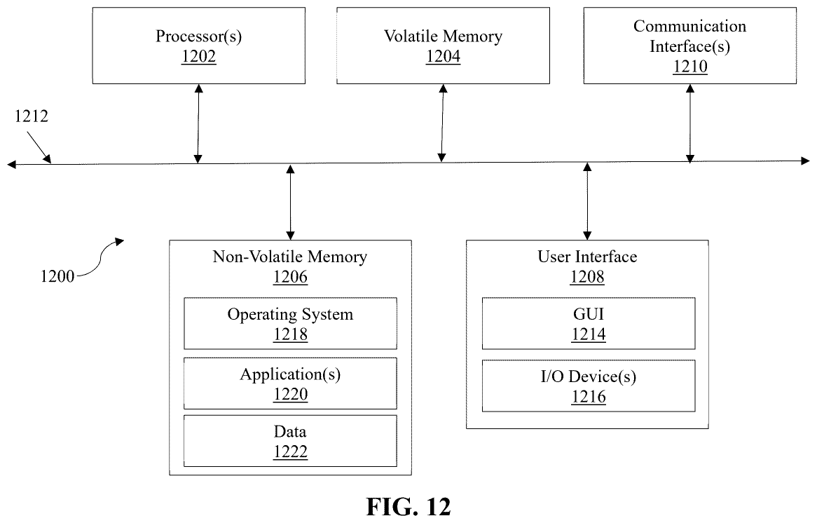

FIG. 12 is a block diagram illustrating selective components of an illustrative computing device 1200 in which various aspects of the disclosure may be implemented, in accordance with an embodiment of the present disclosure. For instance, user devices 105 and/or server 110 of FIG. 1A can be substantially similar to computing device 1200. As shown, computing device 1200 includes one or more processors 1202, a volatile memory 1204 (e.g., random access memory (RAM)), a non-volatile memory 1206, a user interface (UI) 1208, one or more communications interfaces 1210, and a communications bus 1212.

Non-volatile memory 1206 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 1208 may include a graphical user interface (GUI) 1214 (e.g., a touchscreen, a display, etc.) and one or more input/output (I/O) devices 1216 (e.g., a mouse, a keyboard, a microphone, one or more speakers, one or more cameras, one or more biometric scanners, one or more environmental sensors, and one or more accelerometers, etc.).

Non-volatile memory 1206 stores an operating system 1218, one or more applications 1220, and data 1222 such that, for example, computer instructions of operating system 1218 and/or applications 1220 are executed by processor(s) 1202 out of volatile memory 1204. In one example, computer instructions of operating system 1218 and/or applications 1220 are executed by processor(s) 1202 out of volatile memory 1204 to perform all or part of the processes described herein (e.g., processes illustrated and described with reference to FIGS. 1B and 11). In some embodiments, volatile memory 1204 may include one or more types of RAM and/or a cache memory that may offer a faster response time than a main memory. Data may be entered using an input device of GUI 1214 or received from I/O device(s) 1216. Various elements of computing device 1200 may communicate via communications bus 1212.

The illustrated computing device 1200 is shown merely as an illustrative client device or server and may be implemented by any computing or processing environment with any type of machine or set of machines that may have suitable hardware and/or software capable of operating as described herein.

Processor(s) 1202 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 1202 may be analog, digital or mixed signal. In some embodiments, processor 1202 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 1210 may include one or more interfaces to enable computing device 1200 to access a computer network such as a Local Area Network (LAN), a Wide Area Network (WAN), a Personal Area Network (PAN), or the Internet through a variety of wired and/or wireless connections, including cellular connections.

In described embodiments, computing device 1200 may execute an application on behalf of a user of a client device. For example, computing device 1200 may execute one or more virtual machines managed by a hypervisor. Each virtual machine may provide an execution session within which applications execute on behalf of a user or a client device, such as a hosted desktop session. Computing device 1200 may also execute a terminal services session to provide a hosted desktop environment. Computing device 1200 may provide access to a remote computing environment including one or more applications, one or more desktop applications, and one or more desktop sessions in which one or more applications may execute.

Various embodiments of the concepts, systems, devices, structures and techniques sought to be protected are described. It should, however, be appreciated that alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, e.g., one, two, three, four, etc. The terms “a plurality” are understood to include any integer number greater than or equal to two, e.g., two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A method comprising:
receiving, at a server, from each of a plurality of user devices, user global multi-layer perceptron (MLP) weights generated from one or more images of a shared scene, wherein the user global MLP weights are generated so as to not include personal content of a user;
aggregating the user global MLP weights using secure multi-party computation (SMPC) to further ensure exclusion of personal content; and
sending, from the server to the plurality of user devices, updated weights, wherein the updated weights comprise aggregated global MLP weights.

2. The method of claim 1, further comprising sending, from the server to the plurality of user devices, initial weights.

3. The method of claim 1, wherein the one or more images of the shared scene comprise one or more 2-dimensional (2D) images of the shared scene.

4. The method of claim 1, wherein the one or more images of the shared scene comprise a plurality of images taken at different angles, distances, and times.

5. The method of claim 1, wherein the one or more images of the shared scene comprise the personal content and global content.

6. The method of claim 5, wherein the global content is static content across a plurality of images.

7. The method of claim 1, wherein the personal content is dynamic content across a plurality of images.

8. The method of claim 1, further comprising:
taking at least one 2-dimensional (2D) photo on a first user device of the user devices;
processing, by the first user device, the at least one 2D photo to train associated user global MLP weights, wherein training is performed with a neural radiance field (NeRF) pipeline learns associated user global MLP weights and personal MLP weights, and wherein processing separates personal content from the at least one 2D photo; and
sending, from the first user device to the server, the associated user global MLP weights while keeping personal MLP weights local to the first user device.

9. The method of claim 8, further comprising:
receiving, from the server at the plurality of user devices, the updated weights;
processing, by the first user device, the at least one 2D photo to generate updated user global MLP weights using the updated weights; and
sending, from the first user device to the server, the updated user global MLP weights.

10. The method of claim 9, further comprising obfuscating the updated user global MLP weights before sending the updated user global MLP weights to the server.

11. The method of claim 8, wherein sending, from the first user device to the server, metadata and features associated with 3-dimensional (3D) photo data for camera pose estimation.

12. A server comprising at least one processor; and at least one memory including computer program code, the at least one memory and the computer program code configured to, with the at least one processor, cause the server to perform at least the following:
receive, at the server, from each of a plurality of user devices, at least one global multi-layer perceptron (MLP), wherein the at least one global MLP comprises 3-dimensional (3D) data of a shared scene, and wherein the at least one global MLP includes weights used by the user device to remove personal content from a source document during generation of updated user global MLP weights;
combine the received global MLP to generate a securely aggregated global MLP of the shared scene;
determine updated weights based on the securely aggregated global MLP; and
send, from the server to the plurality of user devices, the updated weights, wherein the updated weights comprise global MLP weights.

13. The server of claim 12, wherein the personal content is dynamic content across a plurality of images.

14. A user device, comprising at least one processor; and at least one memory including computer program code, the at least one memory and the computer program code configured to, with the at least one processor, cause the user device to perform at least the following:
take at least one photo of a shared scene;
receive initial global multi-layer perceptron (MLP) weights from a server;
process the at least one photo to train user global MLP weights and personal MLP weights, wherein training separates personal content from global content from the at least one photo;
send, to the server, the user global MLP weights; and
receive, from the server, updated global MLP weights.

15. The user device of claim 14, wherein the at least one photo comprises a 2-dimensional photo of the shared scene.

16. The user device of claim 14, wherein the at least one photo of the shared scene comprises a plurality of images, and the personal content is dynamic content across the plurality of images.
